(19) United States
(12) Patent Application Publication
(10) Pub. No.: US 2018/0273217 A1
(43) Pub. Date: Sep. 27, 2018

(54) Devices and Methods for Making a Pouch

(71) Applicant: COLGATE-PALMOLIVE COMPANY, New York, NY (US)

(72) Inventors: Thierry BERNARDY, Nances (FR); Joel MILLON, Houilles (FR)

(73) Assignee: Colgate-Palmolive Company, New York, NY (US)

(21) Appl. No.: 15/542,107

(22) PCT Filed: Jan. 8, 2015
(86) PCT No.: PCT/US2015/010643

§ 371 Date: Jul. 7, 2017

(51) Int. Cl. B65B 9/12; B29C 65/20; B29C 65/74; B29C 65/00; B65B 3/02; B65B 51/14; B65B 51/30; B65B 61/10

(52) U.S. Cl. CPC B65B 9/12; B29L 2031/712; B29C 65/7451; B29C 66/8491; B29C 66/1122; B29C 66/4312; B29C 66/4322; B29C 66/71; B29C 66/8161; B29C 66/83221; B29C 66/919; B65B 3/02; B65B 51/14; B65B 51/303; B65B 61/10; B29C 65/20

(57) ABSTRACT

Provided is a device (400) for forming a pouch. The device can include a first sealing section (404) having a curved heat-transfer surface, and a second sealing section (406). The second sealing section (406) can include a first heat-transfer surface (407), a second heat-transfer surface (405), and a heated cutter (408). The heated cutter (408) can be disposed between the first heat-transfer surface (407) and the second heat-transfer surface (405). The device can also include an optional cutting face that accepts the heated cutter.

### BACKGROUND

Embodiments described herein relate to pouch packages for liquid and solid products, a device for use in making such pouch packages, and methods of making such pouch packages.

Pouches are used for the packaging of many products around the world. One reason is that they are easily formed and filled. Another reason is that they use very little plastic in the packaging and from this point of view are considered to be an environmentally preferred package. Pouches in 250 ml and 500 ml sizes are used to contain liquid soaps, bleaches, fabric softeners, glass cleaners, floor cleaners and various automobile cleaning products. In many instances the pouches contain a concentrated product which is poured into a larger bottle with water added to dilute the concentrate and to fill the bottle. Pouches also have the advantages that they require little space and can be more easily stocked and sold by small grocery stores and convenience stores. After use they can be easily rolled or folded into a small pack and discarded.

Solid-waste management and the use of environmentally-friendly packaging continue to be a focus of public concern. Even with the expansion of recycling programs, space in existing landfills is rapidly running out. One of the most practical answers to these issues is material source reduction. Use of a flexible pouch (or sachet) as a refill for bottles presents an option for waste reduction.

Polyvinyl chloride (PVC) is a homopolymer of vinyl chloride. Due to its wide field of applications and its exceptional molecular polarity, PVC can absorb large amounts of plasticizers. Resulting materials that use PVC can be flexible, and can be extruded into films and printed. Accordingly, the use of PVC for flexible pouches has provided some relief in terms of reducing landfill space.

The pouches are conveniently made and filled on form/fill equipment. In this type of equipment the pouch is made from the sheet of multilayer film and filled in a continuous sequence. The multilayer film is fed into the form/fill equipment from a feed roll and is shaped into a tubular member with the longitudinal edges are sealed in an overlap seal arrangement of the inner layer bonding to the outer layer. The lower end of the tubular member is then sealed. The next sequence is for a product to be flowed into the pouch and the other end of the pouch to be sealed. After the other end of the pouch is sealed, the pouch is severed from the tubular member. This is done at the same time as the lower end of the next pouch is being formed from tubular stock. In this way the pouches are continuously formed and filled with a product. They then are case packed and shipped.

Another technique for making pouch packages is to use two sheets of film. The two sheets are bonded together at the edges to form a tubular form which then is filled and divided into pouches in a separate apparatus. In this pouch there is a seal of inner layer to inner layer on all edges. However, since such pouches each have two longitudinal seals will have additional points for a potential failure. It is preferred to have fewer seals since pouches usually will fail at a seal.

During manufacturing of such pouches, films of PVC can be welded using radio-frequency (RF) sealing, which provides advantages over sealing technologies such as impulse heat-sealing and ultrasonic sealing. In RF sealing, RF generators produce an oscillating current at a given frequency, and the delivered power depends on parameters linked, in part, to the polymeric material being sealed (e.g., loss factor and dielectric constant). The loss factor is a material characteristic that also depends on temperature and frequency. The higher the loss factor, the better the yield of conversion from electrical energy to thermal energy. The loss factor for PVC is higher than many other polymers making it suitable for RF sealing processes. Some polymers are not affected by such RF frequencies and therefore do not weld at all.

Environmentally speaking, PVC has a bad reputation because incineration thereof releases hydrochloric acid that must be neutralized. Additionally, PVC is not compatible with the main plastic waste stream, which is based on polyethylene, such as polyethylene terephthalate (PET). As a result of such issues, some countries have banned PVC for use as a packaging material.

In addition to environmental concerns, plasticized PVC has some limitations in terms of product preservation (i.e., the product stored in a PVC pouch can lose quality over time) and packaging quality. For example, plasticizers from the PVC can migrate into the liquid product and can generate phase separations, viscosity evolution and the release of odors. Migration of plasticizers from the PVC matrix also makes the film harder and the pouch brittle. Additionally, PVC provides only a limited barrier to moisture and volatile ingredients, which leads to weight losses that may conflict with commercial regulations. Additionally, the absorption of solvents from the liquid product stored in such PVC pouches into the PVC material may result in stretched and wrinkled pouches.

Accordingly, an alternative to PVC for use as a pouch material, and a method for manufacturing such pouches would be welcome advances in the art.

### BRIEF SUMMARY

In an embodiment, there is a device for forming a pouch. The device can include a first sealing section having a curved heat-transfer surface and a second sealing section. The second sealing section can include a first heat-transfer surface, a second heat-transfer surface, and a heated cutter. The cutter can be disposed between the first heat-transfer surface and the second heat-transfer surface. The device can also include an optional cutting face that accepts the heated cutter.

In another embodiment there is a method for forming a pouch. The method can include physically contacting at least a portion of a film comprising a thermoplastic with a seal-and-cut tool. The seal-and-cut-tool can include a first sealing section having a curved heat-transfer surface and a second sealing section. The second sealing section can include a first heat-transfer surface, a second heat-transfer surface for sealing a bottom, and a heated cutter. The cutter can be disposed between the first heat-transfer surface and the second heat-transfer surface. The device can also include an optional cutting face that accepts the cutter. The method can also include forming a first pouch by heat-sealing a top-seal portion of the film with heat provided by at least the first heat-transfer surface. The method can also include separating the first pouch while simultaneously heat-sealing the top seal portion of the film. The separating the first pouch from the film can be performed by driving the heated cutter through the film, wherein the cutter is driven through the film adjacent the top seal portion.

Advantages of at least one embodiment include a pouch packaging formed with a pour spout made of recyclable polyethylene. Another advantage provides a method for forming seals, including using a heated cutter, which results in no product residue remaining on the outside edge of seals formed during a pouch manufacturing process. The lack of residue is important particularly for products contained inside the pouch that may evaporate and leave residues like hypoclorite bleach solutions, or that may become contaminated by bacteria such as in the case of product containing organic compounds. Another advantage of at least one embodiment includes a heat-sealing device that includes a heated cutter disposed between heat-sealing surfaces, for heat-sealing and separating pouches formed from a continuous tubular member. One advantage of such a heated cutter is that tubular member being heat-sealed does not need a lubricating layer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a thermoplastic pouch of an embodiment.

FIG. 2 illustrates a general manufacturing process of making the thermoplastic pouch of FIG. 1.

FIG. 3 illustrates a close-up view of generalized sealing and cutting step for forming a pouch according to an embodiment.

FIGS. 4A-4B are side and back views, respectively, of a device for forming pouches according to an embodiment.

FIGS. 5A-5D are cross-sectional views of a device, such as a single-head, seal-and-cut device of the embodiments during operation for forming a pouch from a film comprising thermoplastic according to an embodiment.

FIG. 6 is a process flow chart describing the process of forming a pouch according to an embodiment.

### DETAILED DESCRIPTION

The following description of the preferred embodiments is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

Reference will now be made in detail to the present embodiments, examples of which are illustrated in the accompanying drawings. Wherever possible, the same reference numbers will be used throughout the drawings to refer to the same or like parts.

The following embodiments are described for illustrative purposes only with reference to the Figures. Those of skill in the art will appreciate that the following description is exemplary in nature, and that various modifications to the parameters set forth herein could be made without departing from the scope of the present invention. It is intended that the specification and examples be considered as examples only. The various embodiments are not necessarily mutually exclusive, as some embodiments can be combined with one or more other embodiments to form new embodiments.

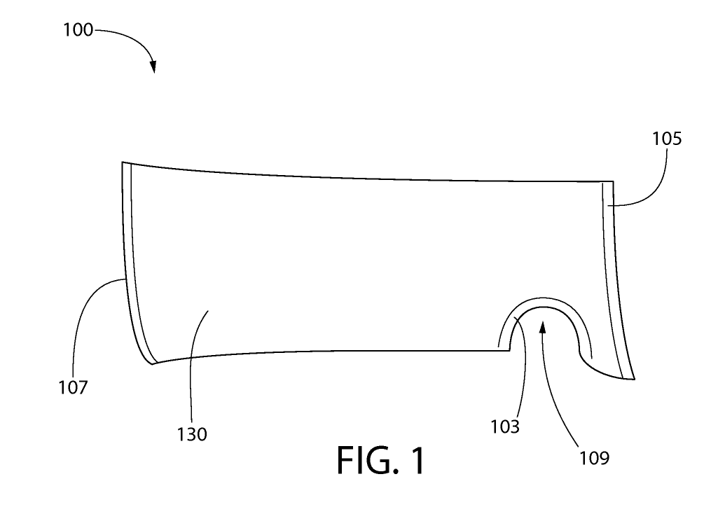

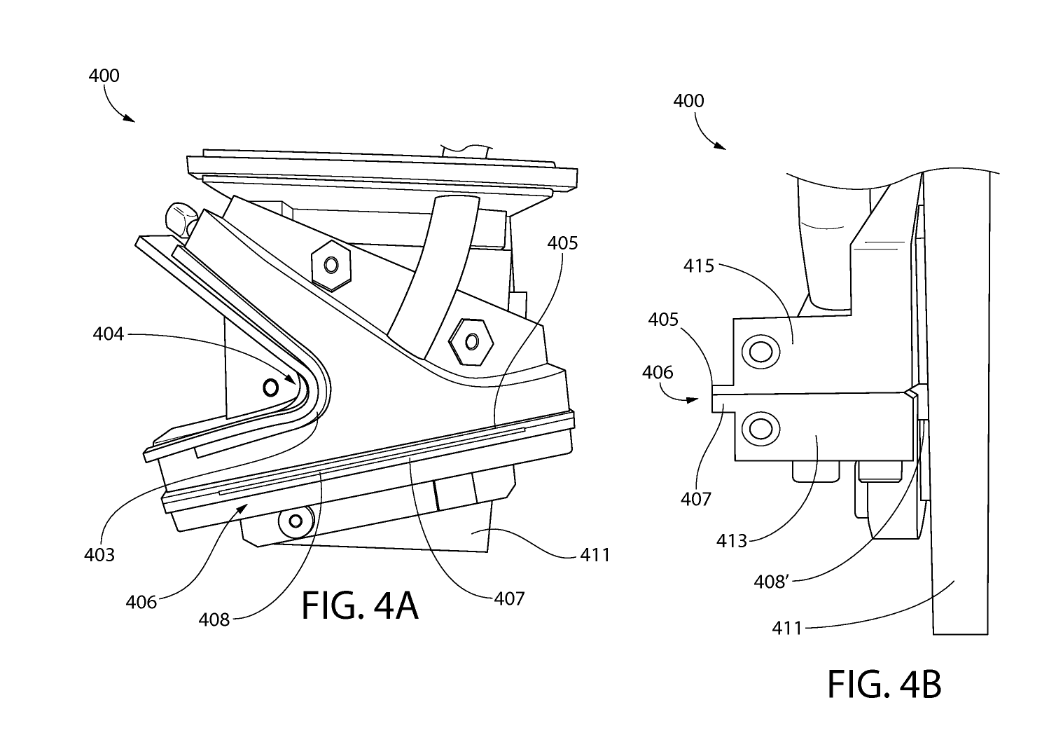

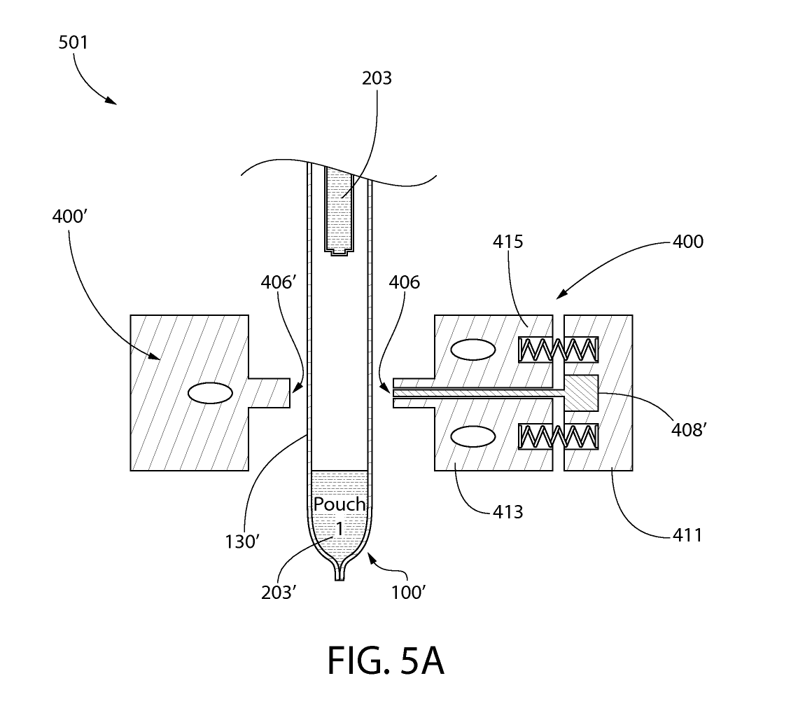

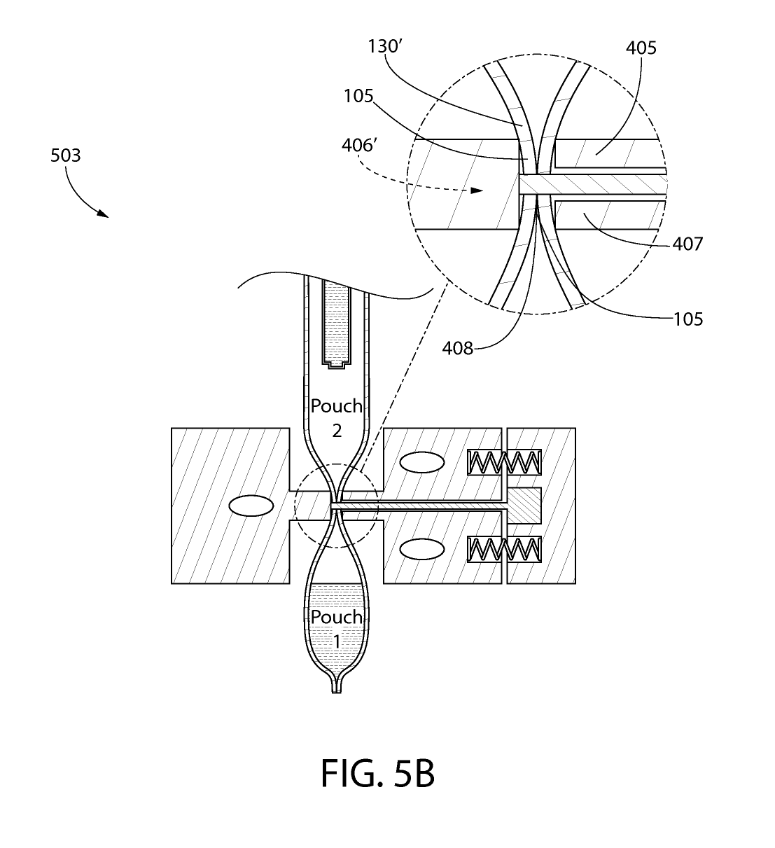

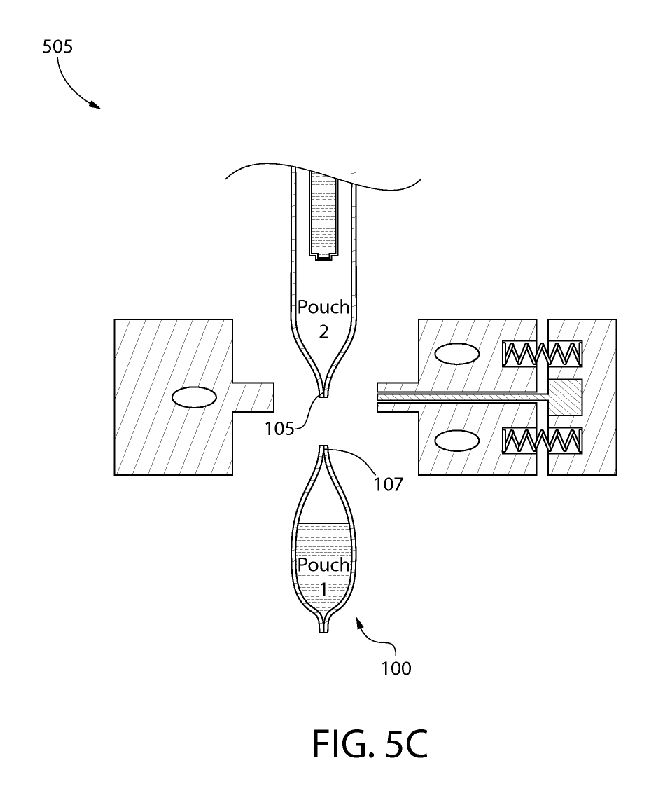

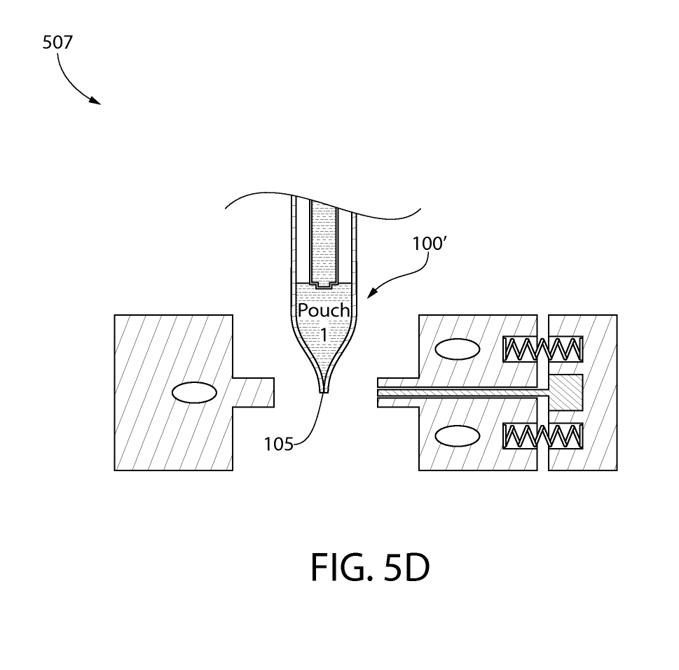

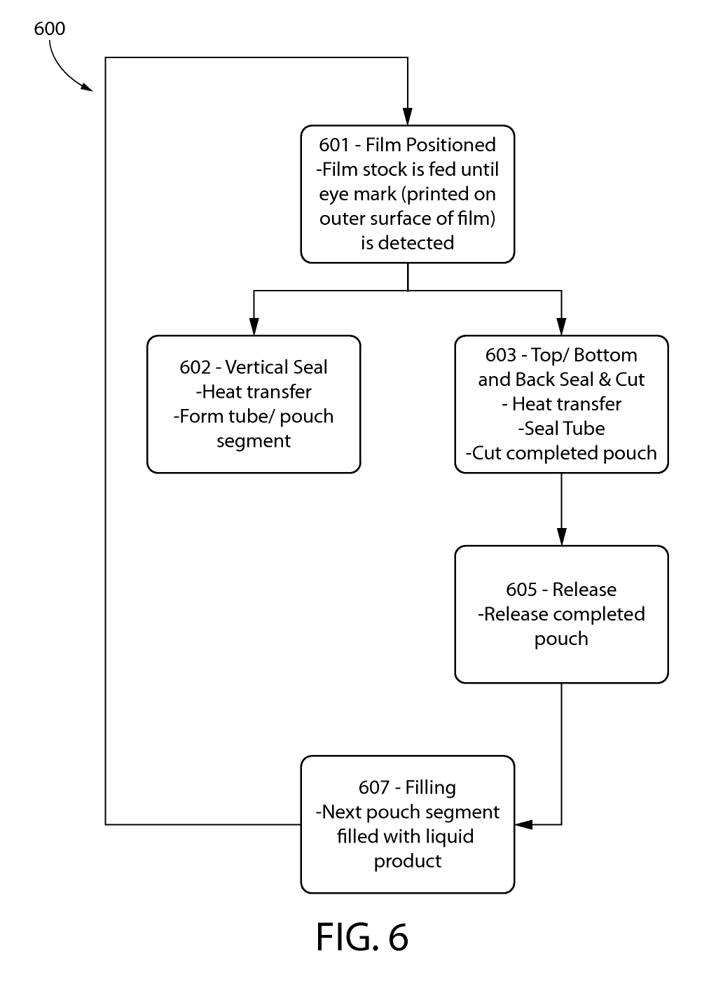

Disclosed herein are embodiments directed to a pouch, such as pouch 100 illustrated in FIG. 1, a device that can be utilized for sealing films, for example, thermoplastic films, such as device 400 illustrated in FIGS. 4A-4B, and a method of forming a pouch, such as in the operation of device 400 to form pouch 100 as illustrated in FIGS. 5A-5D and outlined in the flow-chart of FIG. 6.

Returning to FIG. 1, an embodiment of a pouch 100 can include a recess 109, also referred to as a beak portion, to define a pour spout. The pouch can comprise a film 130.

Pouch 100 can also include narrow and curved seals that minimize or prevent product disposed inside the pouch from leaking out. For example, pouch 100 can include a seal 103 which seals the beak portion 109. Pouch 100 can also be sealed at a first end and a second end. For example, the pouch can include a bottom seal, such as inferior transversal seal 105 and a top seal, such as superior transversal seal 107. In other words, inferior transversal seal 105 can comprise a bottom seal portion of film 130 and superior transversal seal 107 can comprise a top seal portion of film 130. Pouch 100 can also include a vertical seal, also called a longitudinal seal, which can comprise overlap longitudinal seal (not shown) or a side longitudinal seal (not shown), for example, formed in a processing step in which a flat web of film is formed into a tube or sleeve in a processing step of forming pouch 100 as described below.

Pouch film 130, which can comprise a plastic, for example, a thermoplastic, can be sealed using direct heat-transfer, also known as direct heat-sealing. That is, portions of film 130 from which seals 103, 105, and 107 can be “heat-sealed”, for example, between jaws of a device. In other words, unlike PVC which can be sealed using RF sealing, film 130 comprises material that has poor dielectric properties and is, therefore, not sensitive to radio frequency. Accordingly, in an embodiment, film 130 comprises a material that cannot be sealed using RF frequency sealing to form seals such as seals 103, 105 and 107. Instead, pouch 100 comprises film 130 which undergoes at least one heat-sealing operation, for example, simultaneous heat-sealing operations that form seals 103, 105 and 107 as described below. As used herein, “heat-sealing” refers to sealing at least two surfaces together via direct or thermal contact with a heat source but does not refer to sealing via RF sealing. As used herein, an article described as comprising a “heat-seal” or as having been “heat-sealed” means that the article has been constructed, at least in part, via heat-sealing as described above.

By way of example, the pouch film 130 can comprise homopolymers and/or copolymers of polyethylene, polypropylene copolymers and the like. In an embodiment, the pouch packaging can comprise recyclable polyethylene. For example, in an embodiment, the pouch film 130 may comprise copolymer of ethylene and vinyl acetate (EVA), and/or polyamide for added functionality, such as to provide a barrier to prevent ingredient migration or resistance to tampering by children.

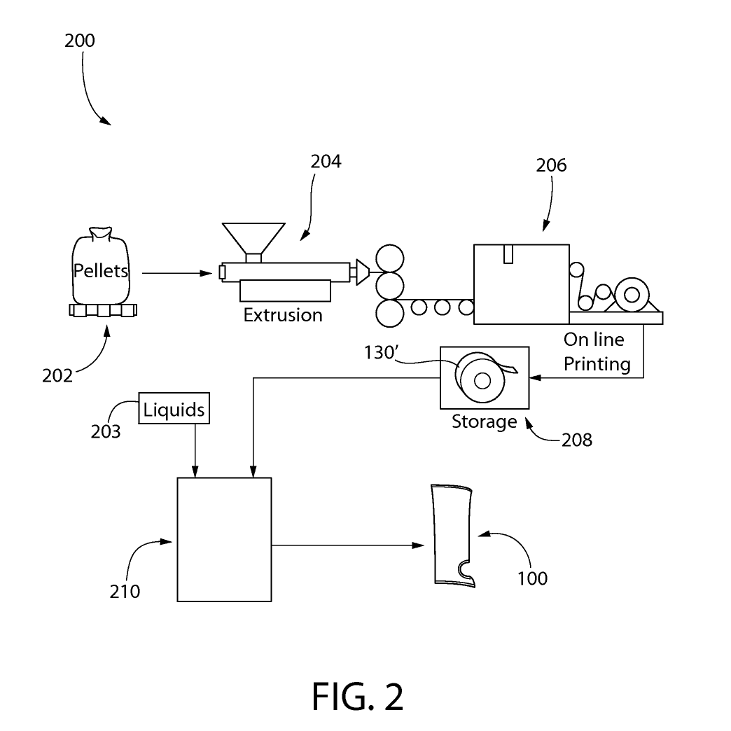

A manufacturing process 200 for forming filled pouch 100, for example, a plurality of filled pouches, is illustrated in FIG. 2. Starting from pelletized polymer 202, a flat web of film pouch film 130′ to be formed into tubular member 130″ can be formed via extrusion 204. In an embodiment, the flat web of film 130′ can itself be a single layer (monolayer) film comprising a thermoplastic, a co-extruded multilayer film comprising a thermoplastic, or can be a multilayer laminate film comprising a plurality of layers, one of which comprises a thermoplastic. The thermoplastic is configured in the film such that when it is exposed to direct heat, it melts such as in a heat-sealing process for forming seals 103, 105 and 107 of pouch 100. In the case that the flat web of film 130′ comprises a multi-layer laminate, the individual films can be laminated together in a lamination process 206 that can include the addition of adhesive between laminated layers. In other words, a single film or more than one film can be processed through a roll system in which the various layers are laminated together to form the flat web of film 130′. The multilayer film will have a thickness of about 90 microns to about 350 microns, and preferably about 130 microns to about 250 microns. The seal layer will have a thickness of about 10 microns to about 80 microns, and preferably about 15 microns to about 50 microns. The barrier layer will have a thickness of about 20 microns to about 100 microns and preferably about 30 microns to about 70 microns. There also can be adhesive tie layers between the seal and barrier layer and the barrier layer and another layer, such as a structural layer. Such layers will have a thickness of about 5 microns to about 15 microns, and preferably about 10 microns. An eye-mark, for tracking the location of increments of film 130′ that are utilized for forming the individual ones of the plurality of pouches, can be printed on an exterior surface of the pouch in an in line printing process. The flat web of film 130′ can then be stored 208 as a roll. It is noted that in line printing is not mandatory and printing may be performed in an off-line process.

The pouches 100 are formed in a form/fill process 210 in which the flat web of film 130′ can be formed into a tubular member 130″. The tubular member is formed having a longitudinal seal that can be an overlap longitudinal seal or a longitudinal fin seal. In the case of an overlap longitudinal seal, the flat web of film 130′ comprises a sealant layer on both sides of the film, such as on an inner surface and an outer surface, such that sealant on one side of the film is bonded to sealant on the other side of the film to form the longitudinal seal on a rear surface of the pouch. In the case of a fin longitudinal seal, such a seal is formed on a side surface of the pouch, wherein the pouch comprises a multilayer film and the fin seal comprises an inner layer to inner layer seal such as that described, for example, with respect to at least direct heat-sealing of a longitudinal fin seal in U.S. Pat. No. 5,806,983 patented on Sep. 15, 1998 (and filed on Jul. 5, 1996), the contents of which are incorporated by reference herein in its entirety.

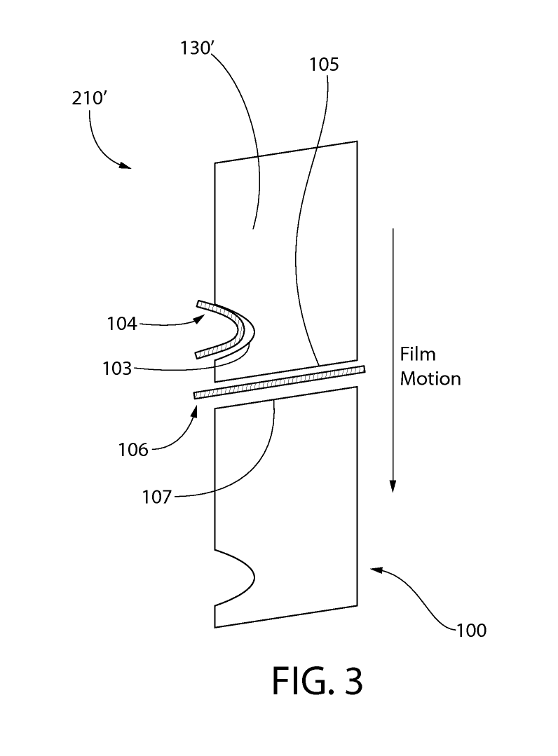

A lower, or bottom seal 105 is then made and the pouch 100 can be filled with product 203, for example, liquids including bleach or fabric softener. At the time that the bottom seal 105 is made, the recess 109 is formed. The other end of the pouch is sealed after filling and the pouch is severed from the tubular member 130″ to which it is attached. As illustrated in FIG. 3, during an n^{th} form/fill operation 210′ of a continuous form/fill process 210, the recess 109 of a pouch 100 is formed with a first sealing section 104 of a sealing device. Meanwhile bottom seal 105, top seal 107 are formed with a second heat-sealing section 106 of the sealing device. Additionally, pouch 100 is also severed from tubular member 130″ by a cutter that can be incorporated in sealing section 106 of the sealing device as described below. In other words, during a the n^{th} film/form operation 210′ of a continuous form/fill process 210, the portions of tubular member 130″ that are sealed by second sealing section 106 become the upper seal of one pouch 100 and the bottom seal of the subsequent pouch.

As described above, a flat web of film 130′ can be formed into a tubular member 130″. The tubular member 130″ can then be sealed to form pouch 100 by a device, such as device 400 illustrated in FIGS. 4A-4B. Accordingly, device 400 can be used for forming pouch 100, including forming bottom seal 105, top seal 107, sealed recess 109. Device 400 can also incorporate features, such as a heated cutter, for severing a completed pouch 100 from the portion of tubular member 130″ that will form a subsequent pouch as described above. Device 400 can include a first sealing section 404 having a curved heat-transfer surface 403, and a second sealing section 406. The second sealing section 406 can include a first heat-transfer surface 407, a second heat-transfer surface 405, and a heated cutter 408. The heated cutter 408 can be disposed between the first heat-transfer surface 407 and the second heat-transfer surface 405. The device 400 can correspond to a first jaw of a direct heat-sealing apparatus which can be pressed against a second jaw to heat-seal a surface of an item, such as a tubular member 130″, placed between the first and second jaws. In other words, during a heat-sealing process, the term “closed” or “closing” as used herein with respect to the jaws, such as in “closing the jaws” or “the jaws are closed” means that the first jaw and the second jaw are pressed together, such as in opposing directions, for example, to heat seal an article disposed between the first and second jaw. Accordingly, device 400 can also include an opposing face which accepts at least one of the first sealing section 404, curved heat-transfer surface 403, and the second sealing section 406. In an embodiment, the opposing face may include an optional cutting face (not visible in FIGS. 4A-4B), that can be moved toward cutter 408, or toward which the cutter 408 can be moved, for example, as the first and second jaws are closed. In another embodiment, the cutting face may move toward the cutter rather than the cutter moving toward the cutting face as described above. In another example, the cutting face and the cutter may move toward one another simultaneously, which may provide for keeping the sealed pouch centered, for example, between the hot bars of the first and second heat transfer surfaces 405, 407, which may allow for it to fall neatly vertically after being severed.

The first heat-transfer surface 407 and the second heat-transfer surface 405 can each comprise a respective one of hot bar for direct heat-sealing of a top seal of a first pouch and the direct heat-sealing of a bottom seal of a subsequent pouch in an n^{th} form/fill operation of a continuous form/fill process. The curved heat-transfer surface 403 can comprise a hot bar which may be caused to heat up via, for example, resistive heating, and is provided for direct heat-sealing of, for example, a recess 109 of a pouch 100. In other words, the first heat-transfer surface 407 is for sealing the top portion 107 of a pouch 100 and the second heat-transfer surface 405 is for sealing the bottom portion 105 of a pouch 100. The heated cutter 408 extends away from the first and second heat-transfer surfaces toward the cutting face and terminates at a cutting edge. By way of example, to separate a completed pouch, the cutter can be moved to penetrate through tubular member 130″ toward the cutting face simultaneously as first 407 and second 405 heat-transfer surfaces form top 107 and bottom 105 seals, respectively. As described below, the cutter 408 is preferably in thermal communication with at least one of the first heat-transfer surface and the second heat-transfer surface. It is noted that cutter 408 can be heated and can remain heated as it penetrates through the film to separate the pouch 100 from the tube member 130″.

In an embodiment, device can be mounted on a support 411. In an embodiment, the first heat-transfer surface 407 is disposed on a substrate, such as a machined block, for example, a first metal block 413. In an embodiment, the curved heat-transfer surface 403 and the second heat-transfer surface 405 are disposed on a common substrate, such as a machined block, for example, a second metal block 415. Accordingly, the first heat-transfer surface 407 can be disposed on a first metal block 413, the second heat-transfer surface can be disposed on a second metal block 415, and the cutter can be disposed between the first metal block and the second metal block. In an embodiment, the cutter extends from a cutting edge on one side of the substrates, that is on one side of first metal block 413 and 415, on which the first and second heat-transfer surfaces are disposed, to a base 408′ on an other side of the substrates, that is on another side of first metal block 413 and 415. The base 408′ can be held in place via compression of the support 411 toward the other side of the substrates via, for example, compression springs. In an embodiment, at least one of the curved heat-transfer surface, the first heat-transfer surface and the second heat-transfer surface are electrically coupled to a respective one of an electrical-energy source.

Turning to FIGS. 5A-5D, sub-operations 501, 503, 505 and 507 are illustrated with respect to a method of manufacturing a pouch according to an embodiment and which can together represent an n^{th} form/fill operation of a continuous form/fill process, and which correspond to the operations described in operations 601, 603, 605 and 607, respectively, of flowchart 600 in FIG. 6. For example, as shown in sub-operation 501 of FIG. 5A and described in step 601 of FIG. 6, tubular member 130″ formed from film 130′ is initially positioned. In an embodiment, film stock (such as from a roll) is automatically fed until an eye mark (not visible in the FIGS), which printed on an outer surface of film 130′, is detected, for example, by an integrated optical sensor. At the front-end of the film stock is a tubular member 130″ formed at 602, including partially formed pouch 100′ segment that has a bottom seal and a vertical seal, and a volume is at least partially filled 203′ with product 203. The tubular member 130″ is, at this point, positioned at a location nearby to device 400, for example between second sealing section 406 and cutting face 406′. It is noted that device 400 in FIGS. 5A-5D may include all of the features described above with respect to FIGS. 4A-4B and may be a seal-and-cut tool used in a seal-and-cut process such as the process of FIG. 6.

At sub-operation 503 of FIG. 5B, and as described in step 603 of FIG. 6, device 400 is activated to form a top seal 107, bottom seal 105, recess seal and/or a back seal on tube member 130″. For example device 400 is activated to initiate the sealing process and the hot bars of the first 407 and second 405 heat-transfer surfaces provide a clamping action on the film 130′. When the film 130′ is held in this manner during the sealing process, at least one of the first and the second heat-transfer surfaces provides heat to the film at a temperature above the film's melting point temperature, thereby causing portions of the film to melt. The flow of molten film from the seal area is restricted by the clamping action. Since the molten portions of the film are trapped in the seal area, better bonding of the two pieces of film on either side of a seal is achieved. Additionally, cutter 408, which may be a thin plate, may be configured to perform the function of a blade, or even a heated blade. Thus, while it may function to cut apart the sealed area to form a top seal 107 of a first pouch and a bottom seal 105 of a second pouch, cutter 408 may also be configured as hot sealing element. For example, first 407 and second 405 heat-transfer surfaces may be in thermal communication with cutter 408. In another example, cutter 408 may be resistively heated independently from first and second heat-transfer surfaces. Accordingly, when film 130′ is clamped, such that two plies of film 130′ are placed in contact with one another, not only do first 407 and second 405 heat-transfer surfaces bond the two plies of film together, but also the cutter 408 may also further melt at least one, or both, of the two plies of the film, to thereby further bond the two plies of film 130′ to each other, such as to the very edge of both the top seal 107 and bottom seal 105. Accordingly, because the two plies of film 130′ may be bonded to each other to the very edges of both the top seal 107 and bottom seal 105, residue may not accumulate on the outside of the top seal 107 and the bottom seal 105. In an embodiment, first heat-transfer surface 407 and second heat-transfer surface 408 form seals having same height and same width. In other words, top seal 107 and bottom seal 105 have the same height and width. Accordingly, cutter 108 is positioned to penetrate through the two plies of film 130′ in the middle between an edge of the top seal 107 and an edge of bottom seal. Said another way, cutter 108 penetrates the tubular member 130″ to sever a first pouch from a subsequent second pouch such that the top seal 107 of the first pouch has the same height and width as a bottom seal 105 of the subsequent pouch.

It is noted that in an embodiment, the first 407 and second 405 heat-transfer surfaces may contact the film 130′ at a constant pressure. In an example, constant pressure can be maintained by calibrated compression springs integrated between the support 411 and the first sealing section (or block 415) and the second sealing sections, such as between the support 411 and as first and second blocks 413 and 415.

As shown in sub-operation 505 of FIG. 5C and described in step 606 of FIG. 6, as second heat-transfer surface 405 forms bottom seal 105 of a subsequent pouch, first heat-transfer surface 407 forms top seal 107, and the cutter 408 is driven through the film 130 until it contacts cutting face 406, a completed first of pouch 100 is separated from the remainder of film 130′ forming part of the upstream tube member. Thus, in a method for forming a pouch, the method can also include separating the first pouch, for example, while simultaneously heat-sealing the top seal portion of the film. The separating the first pouch from the film can be performed by driving the cutting edge through the film, wherein the cutting edge is driven through the film adjacent the top seal portion. The method can also include heat-sealing a recess (not shown in FIGS. 5A-5D) of a subsequent pouch, for example, while simultaneously forming the first pouch. The heat-sealing a recess of a subsequent pouch can be performed with heat provided by at least the curved heat-transfer surface. The method can also include forming a bottom seal of the subsequent pouch, for example, while simultaneously forming the first pouch. The forming the bottom seal of the subsequent pouch can be performed by heat-sealing a bottom portion of the film, wherein the bottom portion of the film is located between the top seal portion and the recess and adjacent to the location through which the cutting edge is driven.

As shown in sub-operation 505 illustrated in FIG. 5D, and as described in step 605 of FIG. 6, device 400 may be configured to release the completed pouch 100. The process continues in sub-operation 507, as described in step 607 of FIG. 6, as a the tube member 130″ is advanced, a volume of the next partially formed pouch segment (i.e., a subsequent pouch) is at least partially filled with product. At this point, over the process starts over and may continue as a cycle.

Unlike conventional methods that utilize RF sealing, the embodiments described herein utilize direct transfer heat-sealing via, for example, first heat-transfer surface 407 and second heat transfer surface 406, to form, for example, seals 105, 107 and 109, along with cutter 408 disposed in a sealing block, wherein the cutter can be used to separate a completed pouch from an upstream film stock and can be heated to further seal the seals 105 and 107 between adjacently formed pouches. Cutter 408 can be a thin blade, for example, having a uniform thickness of 0.4 to 0.3 mm. Cutter 408 can be heated as described above. Cutter 408 may be a rigid cutter. Cutter 408 may be straight or may be curved.

In an embodiment, cutter 408 is not thermally isolated from first 407 and second 405 heat-transfer surfaces. The cutter 408 may be provided at a temperature that improves the sealing qualities of a top seal of a first pouch and a second seal of a subsequently formed by first and second heat-transfer surfaces. For example, the temperature may be selected based on a sealing duration (i.e., a duration of time in which the jaws are closed) and melting temperature of a sealant material, such as a material that provides for the bonding between at least two layers being sealed together. In other words, because the material being sealed needs to absorb a certain quantity of energy to melt, flow and seal. The transferred energy is directly related to the seal duration and temperature. With a given sealing material, preference is always given to the shortest possible seal duration. Accordingly, a temperature for sealing needs to be raised to transfer the energy required. However if the temperature is too high and sealing duration shortened accordingly undesirable side effects can occur, such as undesired plastic flowing or plastic to metal sticking problems may result. A first temperature of 105° C. may be selected as a low limit to melt commonly used PE with EVA copolymers, and a second temperature of 130° C. is a high limit to melt middle density PE used in the film industry. Accordingly, in an embodiment, cutter 408 may be heated to a temperature in the range of about 105° C. to about 130° C., such as a temperature in the range of about 105° C. to about 115° C., as the cutter is driven through plies of film 130′ as described above. However, it is noted that the heated cutter's temperature may be selected based on several factors, including the material of the article being sealed, the distribution of layers forming the article being sealed, an overall thickness of the article being sealed, and the like.

In an embodiment, heat-sealing of a top seal of a pouch occurs simultaneously with heat-sealing of a bottom seal of a subsequent pouch segment. Similarly, heat-sealing a recess of a subsequent pouch segment occurs simultaneously with heat-sealing the bottom seal of the subsequent pouch. Similarly, heat-sealing the bottom seal of the subsequent pouch and heat-sealing the top seal of the first pouch both occur simultaneously with advancing a cutter between the portion of a film at which the top seal is formed and the portion of the film at which the bottom seal is formed. Additionally, constant pressure applied between the first heat-transfer surface and the film, and between the second heat-transfer surface and the film, during heat-sealing of the film, for example, simultaneously as the heated cutter separates a completed pouch and a subsequent pouch between the top and bottom seals of each, respectively, provides an improved method for forming pouches.

### Example 1

A film having an overall thickness of 150 microns is sealed and cut into individual pouches in a machine via a seal and cut tool disposed in the machine. The machine is set-up to 35 cycles per minute and the following settings/parameters: longitudinal (vertical) seal duration 0.7 s; Temperature 80-100° C.; Transversal (horizontal+spout) 0.7 s Temperature 100-120° C.

It is noted that the selected parameters are subject to variation depending mainly upon film thickness and design, which includes material composition and/or layers distribution. Typically sealing time durations can be shortened with film thickness reduction and sealing layer melting temperature decrease. Final parameters/settings are recorded after running the machine for 15-20 mn when the process stability is achieved.

While the present teachings have been illustrated with respect to one or more implementations, alterations and/or modifications may be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages may be added or existing structural components and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A seal and cut tool, comprising:
a first sealing section having a curved heat-transfer surface; and
a second sealing section, comprising
a first heat-transfer surface,
a second heat-transfer surface,
a heated cutter disposed between the first heat-transfer surface and the second heat-transfer surface.

2. The seal and cut tool of claim 1, wherein the first heat-transfer surface and the second heat-transfer surface are each configured for direct heat-sealing of a top seal of a first pouch and the direct heat-sealing of a bottom seal of a subsequent pouch in an n^{th} form/fill operation of a continuous form/fill process.

3. The seal and cut tool of claim 1, wherein the curved heat-transfer surface is configured to provide direct heat-sealing of a recess of a pouch.

4. The seal and cut tool of claim 1, wherein the first heat-transfer surface is for sealing the top portion of a pouch and wherein the second heat-transfer surface is for sealing the bottom portion of a pouch.

5. (canceled)

6. The seal and cut tool of claim 1, wherein the second sealing section further comprises a cutting face that accepts the heated cutter, and wherein the heated cutter extends away from the first heat-transfer surface and the second heat-transfer surface, and extends toward the cutting face.

7. The seal and cut tool of claim 1, wherein the heated cutter is in thermal communication with at least one of the first heat-transfer surface and the second heat-transfer surface.

8. (canceled)

9. The seal and cut tool of claim 1, wherein the first heat-transfer surface is disposed on a first metal block, the second heat-transfer surface is disposed on a second metal block, and the heated cutter is disposed between the first metal block and the second metal block.

10. (canceled)

11. The seal and cut tool of claim 1, wherein the heated cutter is configured to have a temperature of between about 105° C. to about 130° C.

12. A method for forming a pouch, comprising:
physically contacting at least a portion of a film comprising a thermoplastic with a seal-and-cut tool, wherein the seal-and-cut-tool comprises:
a first sealing section, comprising a curved heat-transfer surface; and
a second sealing section, comprising
a first heat-transfer surface,
a second heat-transfer surface,
a heated cutter disposed between the first heat-transfer surface and the second heat-transfer surface
forming a first pouch by heat-sealing a top-seal portion of the film with heat provided by at least the first heat-transfer surface; and
separating the first pouch from the film by driving the heated cutter through the film adjacent to the top-seal portion.

13. The method of claim 12, wherein a volume of the first pouch is at least partially filled with a liquid prior to the separating the first pouch.

14. The method of claim 13, wherein the liquid comprises a bleach solution or a fabric softener.

15. The method of claim 12, further comprising heating at least one of the curved heat-transfer surface, the first heat-transfer surface and the second heat-transfer surface prior to the cutting edge being brought into contact with the film.

16. (canceled)

17. The method of claim 15, wherein the heating comprises heating to a temperature greater than or equal to a melting point temperature of the thermoplastic.

18. The method of claim 12, wherein the thermoplastic comprises one or more selected from the group consisting of polyethylene and polypropylene.

19. The method of claim 12, further comprising heating the heated cutter to a temperature of between about 105° C. to about 130° C.

20. The method of claim 12, wherein the cutter is in thermal communication with at least one of the first heat-transfer surface and the second heat-transfer surface.

21. The method of claim 12, wherein the first heat-transfer surface is disposed on a first metal block, the second heat-transfer surface is disposed on a second metal block, and a portion of the heated cutter is disposed between the first metal block and the second metal block.

22. The method of claim 12, wherein heat-sealing the top seal portion of the film and separating the first pouch from the film are performed simultaneously.

23. The method of claim 12, further comprising simultaneously forming the first pouch and heat-sealing a recess of a subsequent pouch with heat provided by at least the curved heat-transfer surface.

24. The method of claim 23, further comprising simultaneously forming the first pouch and forming a bottom seal of a subsequent pouch by heat-sealing a bottom portion of the film, wherein the bottom portion of the film is located between the top seal portion
